(19) United States
(12) Patent Application Publication
(10) Pub. No.: US 2016/0340936 A1
(43) Pub. Date: Nov. 24, 2016

(54) Laptop Anti-Theft Device

(71) Applicant: Evolve Holdings, LLC, Spring Lake, MI (US)

(72) Inventor: Jason Leonard Burt, Spring Lake, MI (US)

(21) Appl. No.: 15/159,476

(22) Filed: May 19, 2016

Related U.S. Application Data
(60) Provisional application No. 62/164,359, filed on May 20, 2015.

(51) Int. Cl. E05B 73/00

(52) U.S. Cl. CPC E05B 73/0082

(57) ABSTRACT

The device includes a first retention member defining a first retention member top surface opposite, a first retention member bottom surface. The first retention member is selectively moveable between an open position of the first retention member and a laptop restraint position of the first retention member, wherein the first retention member extends against at least a portion of the top surface of the keyboard portion to substantially restrict movement of the laptop when the first retention member is in the laptop restraint position. The second retention member including is selectively moveable between an open position of the second retention member and a laptop restraint position of the second retention member, wherein the second retention member extends against at least a portion of the back surface of the monitor portion to substantially restrict movement of the laptop when the second retention member is in the laptop restraint position.

### RELATED APPLICATION

This disclosure claims priority to U.S. Provisional Patent Application Ser. No. 62/164,359 filed on May 20, 2015.

### TECHNICAL FIELD

This disclosure relates to a laptop anti-theft device.

### BACKGROUND

Due to the small size and ease of portability of many modern computer systems, there is a great concern for physical security of these electronics. Many modern computers including laptops may be easily stolen when an owner looks away or is not present for a short time. Some but not all laptops have a specific lock slot that allow a specific cable or anti-theft device to be used to secure the laptop, but require the owner to find a means for attachment that is secure and to carry the lock with them. Other locking or anti-theft systems that use fixed members attached to a work surface may not be suitable for allowing the work surface to be used as a work surface when the laptop is not present. In many locations it can be desirable to provide physical security for a laptop and/or a common work surface. A locking or anti-theft system protects a laptop or other computer system while still providing a work surface for a user when the laptop is not locked by the locking or anti-theft device.

### SUMMARY

One aspect of the disclosure provides an anti-theft device for a laptop having a keyboard portion with a top surface and a monitor portion with a back surface. The device includes a first retention member defining a first retention member top surface opposite a first retention member bottom surface and a second retention member. The first retention member is selectively moveable between an open position of the first retention member and a laptop restraint position of the first retention member, wherein the first retention member extends against at least a portion of the top surface of the keyboard portion to substantially restrict movement of the laptop when the first retention member is in the laptop restraint position. The second retention member is selectively moveable between an open position of the second retention member and a laptop restraint position of the second retention member, wherein the second retention member extends against at least a portion of the back surface of the monitor portion to substantially restrict movement of the laptop when the second retention member is in the laptop restraint position. The first retention member and the second retention member limit the movement of the laptop when the first retention member and the second retention member are each in the laptop restraint position. When the first and when the first retention member and the second retention member are in the open position, the first retention member top surface and a second retention member engagement surface of the second retention member are substantially co-planar.

Implementations of the disclosure may include one or more of the following optional features. In some implementations, when the first retention member and the second retention member are in the laptop restraint position, the top surface of the keyboard portion is selectively restrained in a first direction by the first retention member bottom surface and the back surface of the monitor portion is selectively restrained by the second retention member engagement surface in a second direction. The first direction and the second direction may be perpendicular. The first retention member and the second retention member may be coupled, at least indirectly to a tray, wherein the tray includes a lip extending at least partially along a periphery of the tray. In some examples, the first retention member is linearly slideable, and indirectly coupled to the tray by way of a frame ring. The second retention member may be indirectly coupled to the tray by way of a pivoting cam bar, which is directly coupled to a frame ring.

In some implementations, the device includes at least one magnet located proximate to at least one of the first retention member or the cam bar. The cam bar may include at least two interference teeth adapted to engage a cam bar latching finger. The device also includes a resettable lock configured to move the cam bar latching finger from an unlocked position not engaging the at least two interference teeth and the cam bar, to a locked position engaging the at least two interference teeth and the cam bar latching finger at least partially prohibiting movement of the cam bar preventing movement of the second retention member from the open position to the laptop restraint position. The cam bar latching finger may further include a cam bar latching finger pivot and the cam bar latching finger pivots around the cam bar latching finger pivot to move from the unlocked position to the locked position. The device may also include an accessory door coupled, at least indirectly to the tray by an accessory door pivot, wherein when the cam bar is in the second cam bar position the accessory door has restricted movement around the accessory door pivot.

Another aspect of the disclosure provides an anti-theft device for a laptop having a keyboard portion with a top surface and a monitor portion with a back surface. The device includes a work platform including a work platform surface, a first retention member, and a second retention member. The work platform forms walls that define a work platform opening in the work platform surface. The first retention member defines a first retention member top surface opposite a first retention member bottom surface. The first retention member is selectively moveable between an open position of the first retention member and a laptop restraint position of the first retention member, wherein the first retention member extends against at least a portion of the top surface of the keyboard portion to substantially restrict movement of the laptop when the first retention member is in the laptop restraint position. The second retention member is at least directly coupled to the work platform, and is selectively moveable between an open position of the second retention member and a laptop restraint position of the second retention member. The second retention member extends against at least a portion of the back surface of the monitor portion to substantially restrict movement of the laptop when the second retention member is in the laptop restraint position. When the first retention member and the second retention member are in the laptop restraint position, the top surface of the laptop is selectively restrained between the work platform surface and the first retention member bottom surface by the first retention member bottom surface and the back surface of the monitor portion is selectively restrained between a second retention member engagement surface of the second retention member and the first retention member by the second retention member engagement surface.

This aspect may include one or more of the following optional features. In some implementations, when the first retention member and the second retention member are in the open position, the first retention member top surface, the second retention member engagement surface, and the work platform surface are substantially co-planar. The device may include a frame ring at least indirectly coupled to a tray at least indirectly coupled to the work platform. The first retention member may be linearly slideable and indirectly coupled to the tray by way of the frame ring. The second retention member may be indirectly coupled to the tray by way of a pivoting cam bar, which is directly coupled to the frame ring.

In some examples, the device includes at least one magnet located proximate to at least one of the first retention member or the cam bar. The cam bar may further include at least two interference teeth adapted to engage a cam bar latching finger. The device may also include a resettable lock configured to move the cam bar latching finger from an unlocked position not engaging the at least two interference teeth and the cam bar, to a locked position engaging the at least two interference teeth and the cam bar latching finger at least partially prohibiting movement of the cam bar preventing movement of the second retention member from the open position to the laptop restraint position. The device may also include an accessory door coupled, at least indirectly to the tray by an accessory door pivot, wherein when the cam bar is in the second cam bar position the accessory door has restricted movement around the accessory door pivot.

Yet another aspect of the disclosure provides an anti-theft device for a laptop having a keyboard portion with a top surface and a monitor portion with a back surface. The device includes: a work platform including a work platform surface; a tray at least indirectly coupled to the work platform; a frame ring at least indirectly coupled to the tray; a first retention member that is linearly slideable; a pivoting cam bar; a second retention member; and a resettable lock. The work platform forms walls that define a work platform opening in the work platform surface. The first retention member is at least indirectly coupled to the work platform by way of the tray, defining a first retention member top surface opposite a first retention member bottom surface, selectively moveable between an open position of the first retention member and a laptop restraint position of the first retention member, wherein the first retention member extends against at least a portion of the top surface of the keyboard portion to substantially restrict movement of the laptop when the first retention member is in the laptop restraint position. The pivoting cam bar includes at least two interference teeth adapted to engage a cam bar latching finger coupled at least indirectly to the tray. The second retention member is coupled to the cam bar and at least indirectly coupled to the work platform, selectively moveable between an open position of the second retention member and a laptop restraint position of the second retention member, wherein the second retention member extends against at least a portion of the back surface of the monitor portion to substantially restrict movement of the laptop when the second retention member is in the laptop restraint position. The resettable lock is configured to move the cam bar latching finger from an unlocked position not engaging the at least two interference teeth and the cam bar, to a locked position engaging the at least two interference teeth and the cam bar latching finger at least partially prohibiting movement of the cam bar preventing movement of the second retention member from the open position to the laptop restraint position. When the first retention member and the second retention member are in the laptop restraint position, the top surface of the laptop is selectively restrained between the work platform surface and the first retention member bottom surface by the first retention member bottom surface. The back surface of the monitor portion may be selectively restrained between a second retention member engagement surface of the second retention member and the first retention member by the second retention member engagement surface. When the first retention member and the second retention member are in the open position, the first retention member top surface, the second retention member engagement surface, and the work platform surface may be substantially co-planar.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an isometric view of a laptop anti-theft device in an open position.

FIG. 2 is an isometric view of the laptop anti-theft device in a laptop restraint position including a laptop.

FIG. 3 is an isometric view of the laptop anti-theft device in the laptop restraint position including the laptop with a lock and an accessory pocket.

FIG. 4 is an enhanced isometric view of a portion of the laptop anti-theft device in the laptop restraint position including the laptop.

FIG. 5 is an embodiment of an exploded view of the laptop anti-theft device.

FIG. 6 is a cutaway side view of the laptop anti-theft device in the open position with the first retention member and second retention member.

FIG. 7 is a cutaway side view of the laptop anti-theft device transitioning from the open position to the laptop restraint position with the first retention member manipulated to a locked position.

FIG. 8 is a cutaway side view of the laptop anti-theft device transitioning from the open position to the laptop restraint position moving the second retention member.

FIG. 9 is a cutaway side view of the laptop anti-theft device transitioning from the open position to the laptop restraint position moving the second retention member to engage the laptop.

FIG. 10 is a cutaway side view of the laptop anti-theft device in the laptop restraint position.

FIG. 11 is an isometric rear view of the laptop anti-theft device in the open position.

FIG. 12 is an isometric rear view of the laptop anti-theft device in the laptop restraint position.

Like reference symbols in the various drawings indicate like elements.

### DETAILED DESCRIPTION

Laptops and other modern computer systems may be at a high risk of being stolen. The term “laptop” and “computing system” may be used interchangeably herein, referring to any portable electronic device a user may wish to secure. Conventional systems often require a user to carry equipment to secure the laptop or interact with a fixture on a work surface or desk, which may interfere with the work surface or desks use when the work surface or desk is not in use. An anti-theft device discussed herein allows a user to secure a laptop when required, yet still allows a user to use the work surface when the laptop is not present. In at least one implementation, the anti-theft device provides a non-portable system for securing a laptop while still allowing the work surface to be used normally without a laptop.

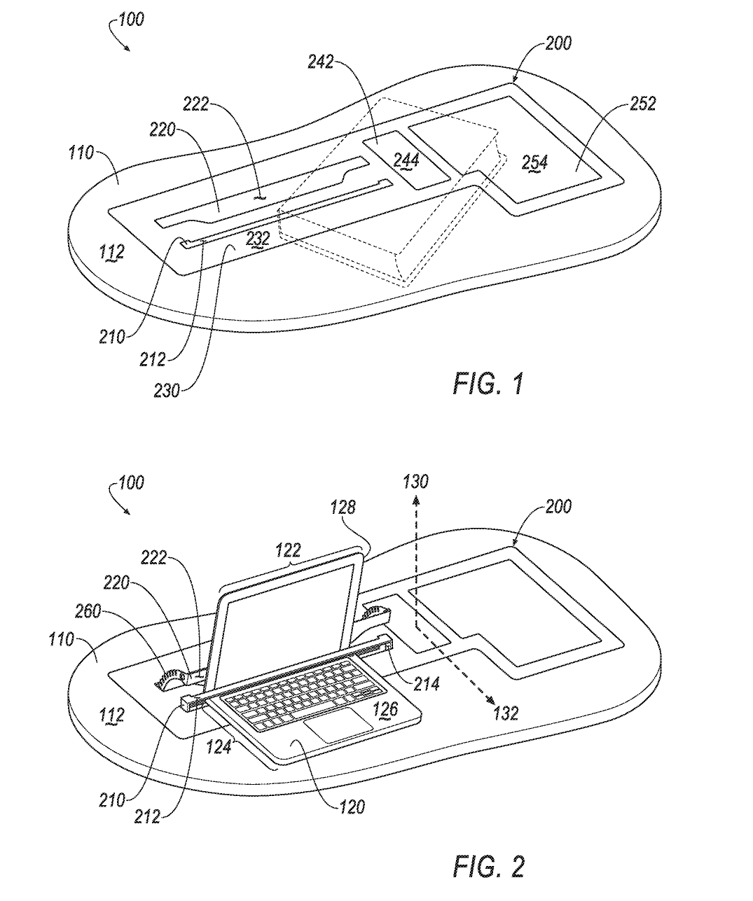

FIG. 1 is an isometric view of a laptop anti-theft device 100 in an open position 202. In at least one embodiment, the laptop anti-theft device 100 may include a work platform 110. The work platform 110 may include a work surface 112. The work surface 112 may be a flat surface or may be a curved surface to facilitate the use of general activities by users. Common uses of a work surface include but are not limited to reading, operating a computer, research, writing, and/or calculating, etc. The work platform 110 and work surface 112 may be any common shape to facilitate the common uses of the work surface 112. The work platform 110 may include a locking system 200 attached to the work platform 110. The locking system 200 in FIG. 1 is shown in the open position 202. For the purposes of this disclosure “open position” shall be interpreted as a position where a lock 246 does not restrict movement of the locking system 200. The locking system 200 may include a first retention member 210 and a second retention member 220. Retention members 210, 220 may be located approximately parallel to one another. The first retention member 210 may include a first retention member top surface 212. The second retention member 220 may include a second retention member engagement surface 222. When in the open position 202, the first retention member top surface 212 and second retention member engagement surface 222 may be approximately co-planer. In some examples, the first retention member top surface 212, the second retention member engagement surface 222, and the work surface 112 are approximately co-planer when in the open position 202. The first retention member 210 and second retention member 220 may be associated with a trim ring 230. The trim ring 230 may be a cover having a planer surface used to cover the internal workings of the laptop anti-theft device 100. The trim ring 230 may include a trim ring surface 232. The trim ring surface 232 may be approximately co-planer with the first retention member top surface 212, the second retention member engagement surface 222, and/or the work surface 112 when the first retention member top surface 212 and the second retention member engagement surface 222 are in the open position 202.

The locking system 200 may include a lock door 242 and an accessory door 252. The lock door 242 may include a lock door surface 244 and the accessory door 252 may include an accessory door surface 254. The lock door surface 244 and/or the accessory door surface 254 may be approximately co-planer with the first retention member top surface 212, the second retention member engagement surface 222, the trim ring surface 232 and/or the work surface 112.

FIG. 2 is an isometric view of the of the laptop anti-theft device 100 in a laptop restraint position 204 including a laptop 120. The laptop 120 may include a monitor portion 122 and lower portion of the laptop 120 which may include a keyboard portion 124. The monitor portion 122 and/or keyboard portion 124 may refer to the general areas or portions of the laptop 120 and do not designate a specific required function or the presence of specific hardware. The keyboard portion 124 may include a top surface 126, and the monitor portion 122 may include a back surface 128. The top surface 126 and the back surface 128 may be approximately perpendicular to each other when the laptop 120 is open. The first retention member 210 may be extended to allow the keyboard portion 124 of the laptop 120 to be placed below the first retention member 210 and above the work surface 112. The first retention member 210 and the work surface 112 may restrict the movement of the laptop 120 in a first direction 130. The second retention member 220 may be attached to a cam bar 260. The cam bar 260 may pivot allowing the second retention member 220 to move from the open position 202 to the laptop restraint position 204. The second retention member engagement surface 222 may be manipulated against the monitor portion 122 of the laptop 120 sandwiching the laptop 120 between the second retention member 220 and the first retention member 210, thereby restricting movement of the laptop 120 in the second direction 132. The restriction of movement of the laptop 120 in both the first direction 130 and the second direction 132 may prevent the laptop 120 from being removed from the work platform 110 while the first retention member 210 and second retention member 220 are in the laptop restraint position 204. The first direction 130 and the second direction 132 may be generally perpendicular.

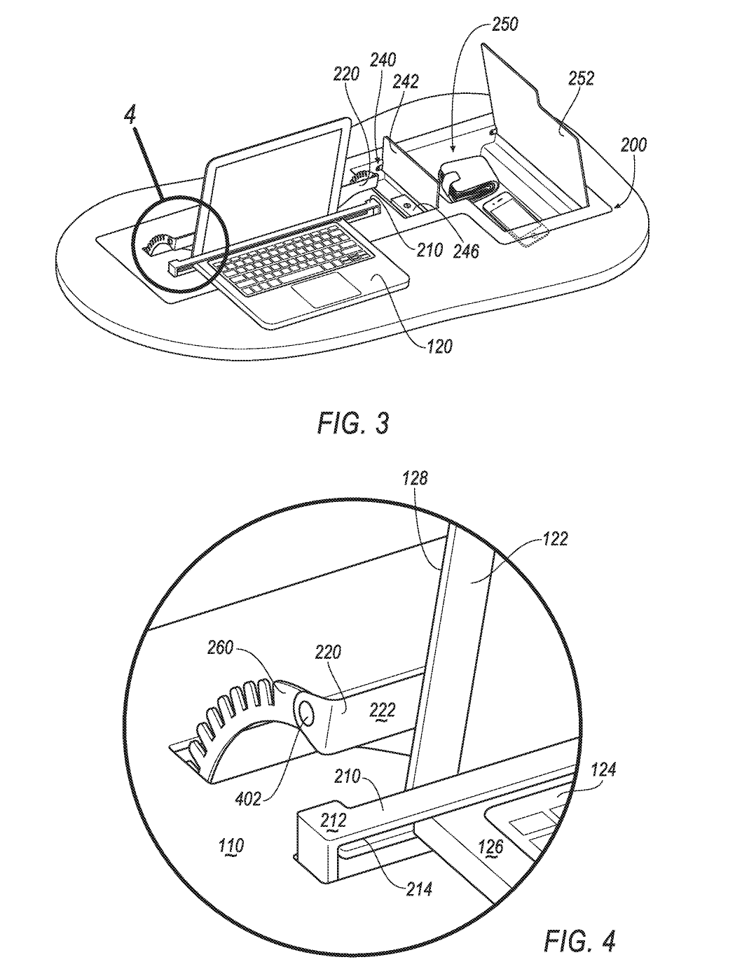

FIG. 3 is an isometric view of the laptop anti-theft device 100 in the laptop restraint position 204 including the laptop 120 with a lock 246 and an accessory pocket 250. The locking system 200 may include a lock pocket 240. The lock pocket 240 may be a recess or cavity associated within the locking system 200. Contained within the locking pocket 240 may be a lock 246. The locking pocket 240 may be closed by a locking door 242. In some examples, the locking door 242 is not directly or indirectly connected to the lock 246. The lock 246 may be any type of lock including, but not limited to, a combination lock, a key lock, a fingerprint lock, a biometric lock, and/or a retina lock, etc. In some examples, the lock 246 is a combination lock that resets the combination each time the lock 246 is unlocked. For example, a first combination may be entered into the lock 246 and the lock 246 may be actuated locking the lock 246 thereby locking the laptop anti-theft device 100. Upon entry of the first combination, the lock 246 may be unlocked, unlocking the laptop anti-theft device 100. When the lock 246 is unlocked, a second combination may be entered into the lock 246. The second combination may be different or the same. The lock 246 may be locked resulting in locking the laptop anti-theft device 100. When the lock 246 is locked after the second combination has been entered into the lock 246, the lock 246 may be unlocked upon entry of the second combination into the lock 246 resulting in unlocking the laptop anti-theft device 100. The lock 246 may be indirectly connected to the second retention member 220 and/or the accessory door 252. When the lock 246 is locked the lock 246 may restrict movement of the second retention member 220 restricting the movement of the laptop 120 resulting in the laptop 120 being secure. The locking system 200 may include an accessory pocket 250. The accessory pocket 250 may be a recess or cavity associated within the locking system 200. The accessory pocket 250 may be closed by an accessory door 252 at least indirectly connected to the lock 246. The actuation of the lock 246 may allow the accessory door 252 to be secured to allow one to protect valuables or objects associated within the accessory pocket 250.

FIG. 4 is an enhanced isometric of a portion of the laptop anti-theft device 100 in the laptop restraint position 204 and including the laptop 120. The first retention member 210 may include the first retention member top surface 212 and opposite the first retention member top surface 212 may be a first retention member bottom surface 214. The first retention member bottom surface 214 may be adjacent to or in contact with the top surface 126 of the keyboard portion 124. The first retention member bottom surface 214 of the first retention member 210 may restrain the keyboard portion 124 between the first retention member bottom surface 214 and the work surface 112. The first retention member bottom surface 214, the work surface 112, and the top surface 126 of the keyboard portion 124 may be approximately parallel. The second retention member 220 may be attached to the cam bar 260 by a pivot 402. The pivot 402 may allow the second retention member 220 to be manipulated. The second retention member engagement surface 222 may be aligned approximately with the back surface 128 of the monitor portion 122. The second retention member 220 may be manipulated around the pivot 402 allowing the second retention member engagement surface 222 to be aligned or engage the back surface 128 of the monitor portion 122. The cam bar 260 may prevent movement of the second retention member 220 and therefore restrict movement of the laptop 120 by restricting the monitor portion 122 between the first retention member 210 and the second retention member engagement surface 222 of the second retention member 220.

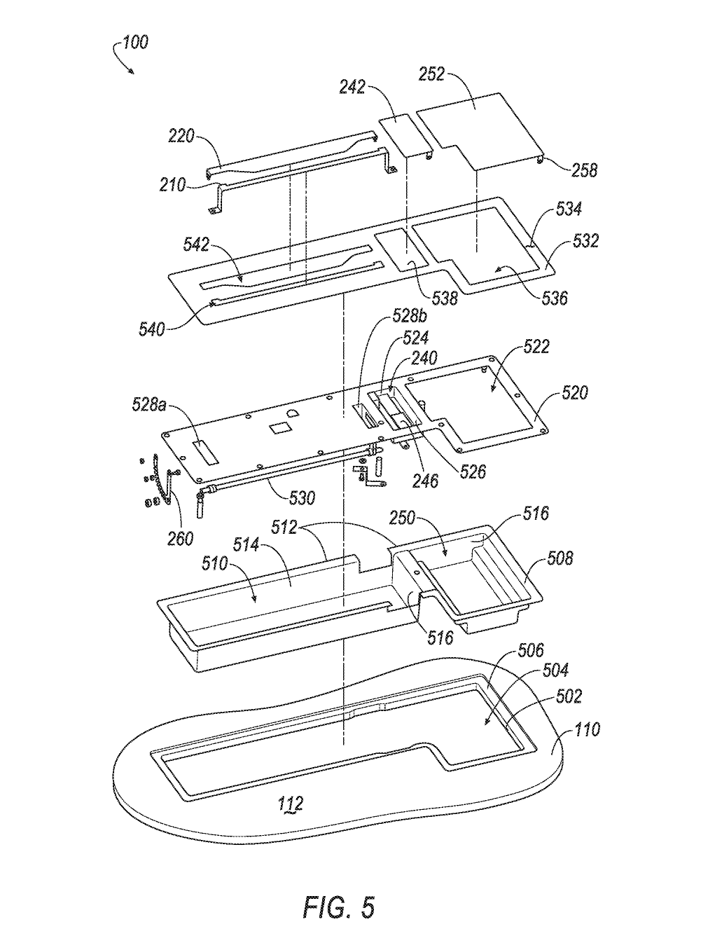

FIG. 5 is an embodiment of an exploded view of the laptop anti-theft device 100. The work platform 110 may include walls 502 that extend to define a work platform opening 504. The work platform opening 504 may be surrounded by a depression or lip 506 along some or all of the periphery of the work platform opening 504. A tray 508 may be associated within the opening 504 and include a first cavity 510 and the accessory pocket 250. The outer periphery of the tray 508 may include a lip 512 extending away from one or more of the walls 514 along a portion or all of the tray 508. The walls 514 of the tray 508 may extend to define the first cavity 510 and the accessory pocket 250. The walls 514 of the tray 508 may also form the structure of the tray 508. A partition 516 associated within the tray 508 may separate the first cavity 510 from the accessory pocket 250. The partition 516 may be one or more of the walls 514 of the tray 508. The work platform opening 504 may be configured to accept the shape or projective top view of the tray 508. The lip 512 of the tray 508 may be configured to match with the lip 506 of the work surface 112 allowing the tray 508 to be seated in the work platform 112. In some examples, the tray 508 may be secured to the work platform 110 using glue or other fasteners. A frame ring 250 may be included and the frame ring 520 may provide structural support and mounting locations. The frame ring 520 may include a first opening 522 allowing access to the accessory pocket 250. The frame ring 520 may also include a second opening 524 allowing access to the lock pocket 240. The second opening 524 for the lock pocket 240 may be formed by walls 526 that define the cavity of the locking pocket 240 containing the lock 246. A third opening 528a and a fourth opening 528b may be included in the frame ring 520. The third opening 528a and the fourth opening 528b may be configured to allow part of the first retention member 210, second retention member 220, and/or the cam bar 260 to pass through the third opening 528a and the fourth opening 528b. One or more cam bars 260 may be connected using a support 530. The support 530 may be located between the tray 508 and the frame ring 520. The support 530 may be a rod or other mechanical device to couple the movement of more than one cam bar 260 to allow multiple cam bars 260 to move in unison. The frame ring 520 may be secured to the tray 508. A trim ring 532 may be secured to the frame ring 520. The trim ring 532 may include a trim ring surface 534. The trim ring surface 534 may be approximately co-planer to the work surface 112. The trim ring 532 may include an accessory door opening 536 of the projected shape of the accessory door 252. The trim ring 532 may include a lock door opening 538 of the projected shape of the lock door 242. The trim ring 532 may include a first retention member opening 540 of the projected shape of the first retention member 210. The trim ring 532 may include a second retention member opening 542 of the projected shape of the second retention member 220. The accessory door 252 may include an accessory door pivot 258 connected to the tray 508. The first retention member 210, the second retention member 220, the lock door 242, and/or the accessory door 252 may pass through the trim ring 532 at least indirectly connecting to the frame ring 520. In some examples, the second retention member 220 is connected to the cam bar 260, which is connected to the frame ring 520. The trim ring 532 may be secured to the frame ring 520. The frame ring 520 may be connected to the tray 508. The tray 508 may be connected to the work platform 110.

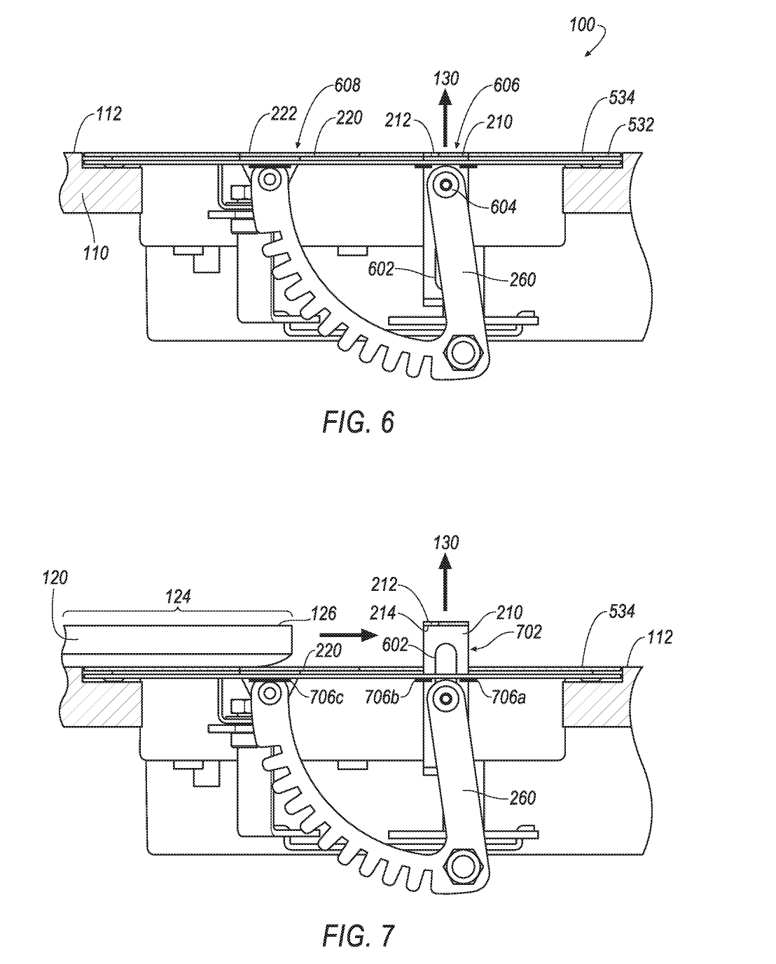

FIG. 6 is a cutaway side view of the laptop anti-theft device 100 in the open position 202 with the first retention member 210 and the second retention member 220. The first retention member 210 and the second retention member 220 may be recessed such that the first retention member top surface 212 and the second retention member engagement surface 222 may be co-planer. The first retention member top surface 212 and the second retention member engagement surface 222 may be co-planer with the work surface 112 of the work platform 110. The first retention member top surface 212, the second retention member engagement surface 222, and/or the work surface 112 may be co-planer with the trim ring surface 534 of the trim ring 532. The first retention member 210 may include a slot 602 configured to allow limited movement in a first direction 130. The slot 602 of the first retention member 210 may engage a bolt 604 or pivot. The bolt 604 may be any suitable member to retain the first retention member 210 yet allow limited movement in the first direction 130. When the first retention member top surface 212 and the second retention member engagement surface 222 are co-planer, the first retention member 210 may be considered in the open position 606 for the first retention member 210. When the first retention member top surface 212 and the second retention member engagement surface 222 are co-planer, the second retention member 220 may be considered in the open position 608 for the second retention member 220. A user may move the first retention member 210 along the first direction 130 allowing it to be extended out of the work surface 112 altering the co-planer status of the first retention member 210 and the work surface 112.

FIG. 7 is a cutaway side view of the laptop anti-theft device 100 transitioning from the open position 202 to the laptop restraint position 204 with the first retention member 210 manipulated to its laptop restraint position 702. The first retention member 210 has been manipulated away from the open position 606 of the first retention member 210 to the laptop restraint position 702 of the first retention member 210. The movement of the first retention member 210 from the open position 606 to the laptop restraint position 702 creates an area under the first retention member 210 for partially engaging the laptop 120. The laptop 120 may be slid or manipulated along the work surface 112 and/or the trim ring surface 534 to allow the top surface 126 of the keyboard portion 124 to be below the first retention member 210 and in contact with and/or below the first retention member bottom surface 214. In some examples, the first retention member bottom surface 214 is partially in contact with the top surface 126 of the keyboard portion 124. The second retention member 220 may remain in the open position 608 of the second retention member 220 to allow the movement of the laptop 120 and keyboard portion 124. The total movement of the first retention member 210 may be limited by the length of the slot 602 engaging the bolt 604.

In some examples, the laptop anti-theft device 100 includes one or more magnets 706, 706a-706c. One or more of the magnets 706 may be located within magnetic proximity to the first retention member 210, the second retention member 220 and/or the cam bar 260. The magnets 706 may be indirectly connected to the tray 508. The magnets 706, 706a, 706b may be located such that the first retention member 210 may experience a frictional drag caused by the interaction between the first retention member 210 and the magnets 706, 706a, 706b impeding motion along the first direction 130. The magnetic attraction created by the magnets 706, 706a, 706b may impede motion along the first direction 130 and may prevent the first retention member 210 from moving by gravitational forces exerted on the first retention member 210. The magnetic attraction created by the magnets 706a, 706b may impede the first retention member 210 from moving from the laptop restraint position 704 to the open position 606 by gravitational forces. The magnets 706, 706a, 706b may provide frictional drag caused by the interactions of the magnets 706, 706a, 706b and the first retention member 210 allowing the first retention member 210 to remain where the user places the first retention member 210 while positioning the laptop 120 and/or locking the second retention member 220.

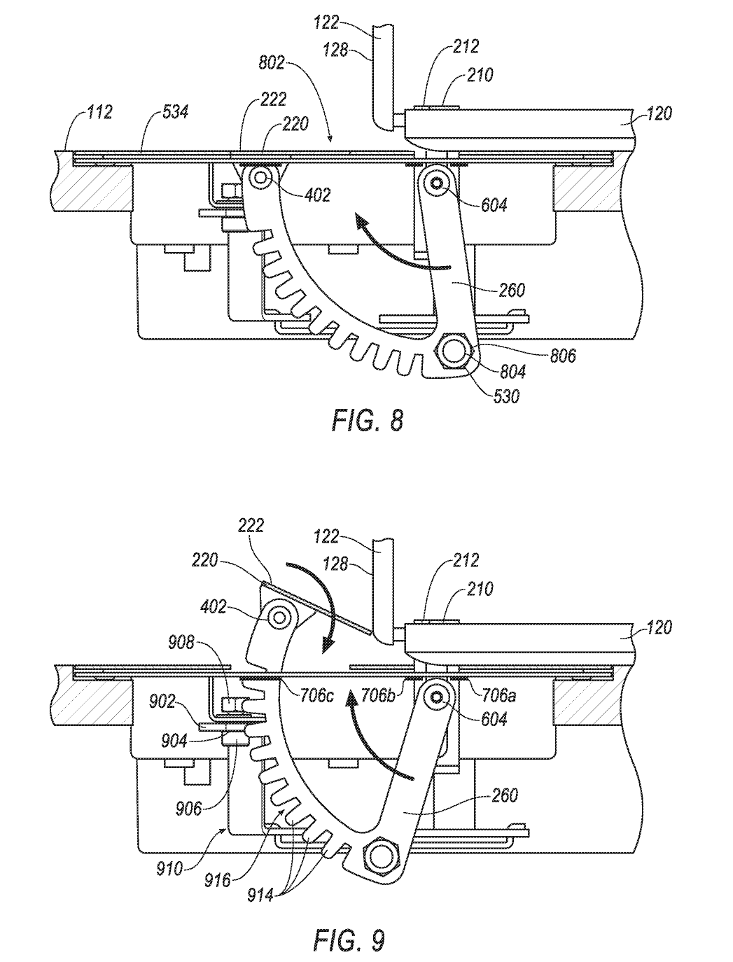

FIG. 8 is a cutaway side view of the laptop anti-theft device 100 transitioning from the open position 202 to the laptop restraint position 204 by moving the second retention member 220. The laptop 120 may be impeded by the first retention member 210 from movement in a normal direction from the work surface 112 or the trim ring surface 534. The second retention member 220 may be connected to the cam bar 260 by a pivot 402. When the second retention member 222 is co-planer with the work surface 112 and/or the first retention member top surface 212, the second retention member 222 may be in the open position 802. The cam bar 260 may pivot around the bolt 604 to allow motion in a radial direction moving the second retention member 220 towards the back surface 128 of the monitor portion 122 of the laptop 120. In some examples, the pivot of the cam bar 260 is a separate bolt 604 or articulating member than the slot 602 of the first retention member 210 moves on. The cam bar 260 may include a hole 804 to connect the cam bar 260 to the support 530 connecting one or more cam bars 206 together. The support 530 may be secured by the use of a nut 806.

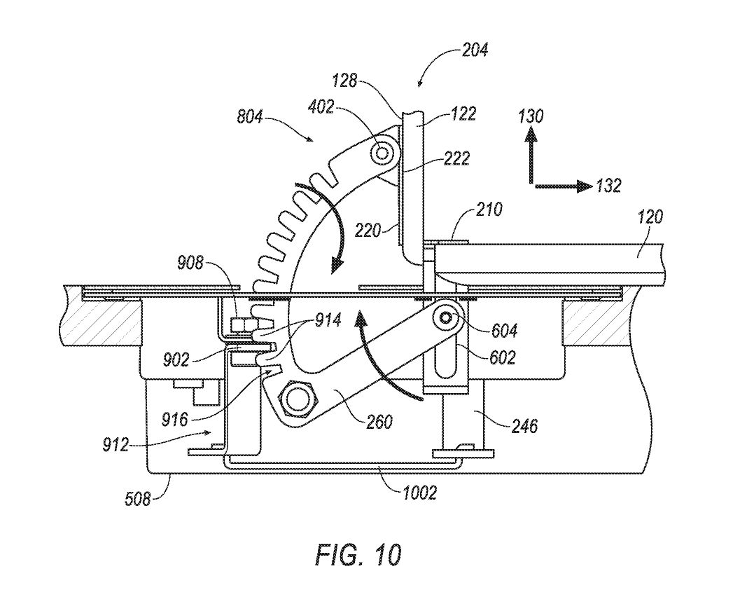

FIG. 9 is a cutaway side view of the laptop anti-theft device 100 transitioning from the open position 202 to the laptop restraint position 204 moving the second retention member 220 to engage the laptop 120. The cam bar 260 may rotate around the bolt 604 moving the second retention member 220 toward the monitor portion 124 of the laptop 120. The second retention member 220 may rotate around the pivot 402 as it moves towards the monitor portion 124 of the laptop 120. The second retention member 220 may be rotated around the second retention member engagement surface 222 as the cam bar 260 rotates around the bolt 604 to partially align with the back surface 128 of the monitor portion 122. The second retention member 220 and the cam bar 260 may rotate independently. A cam bar latching finger 902 may be included and move around a pivot 904. The pivot 904 of the cam bar latching finger 902 may be secured by a bolt 906 and a nut 908. The cam bar latching finger 902 may be actuated by the lock 246 to move from an open position 910 of the cam bar latching finger 902 to a laptop restraint position 912 (shown in FIG. 10) of the cam bar latching finger 902. The cam bar latching finger 902 may be configured to engage one or more interference teeth 914 on the cam bar 260. A void 916 may be created by the interference teeth 914. The cam bar latching finger 902 may enter the void 916 resulting in contact with one or more of the interference teeth 914 prohibiting movement of the cam bar 260. The open position 910 of the cam bar latching finger 902 may not interfere with the interference teeth 914 of the cam bar 260, allowing the cam bar 260 to pivot around the bolt 604 moving the second retention member 220 from the open position 802 of the second retention member 220 to a laptop restraint position 804 (shown in FIG. 10) of the second retention member 220.

In some examples, one or more magnets 706, 706c may be located such that it magnetically impedes the motion of the cam bar 260 and/or the second retention member 260. The one or more magnets 706, 706c may be located such that the second retention member 220 and/or cam bar 260 may experience a frictional drag caused by the interaction of the magnets 706, 706c between the second retention member 220 and/or the cam bar 260 when the second retention member 220 is manipulated from the open position 802 to the laptop restraint position 804. The magnetic attraction between the magnets 706, 706c and the cam bar 260 may provide support to the cam bar 260 thereby preventing the gravitational forces acting on the second retention member 220 from moving the second retention member 220 and/or the cam bar 260. The one or more magnets 706, 706c may allow the user to maintain the position of the second retention member 220 while locking the second retention member 220 resulting in the laptop anti-theft device securing the laptop 120.

FIG. 10 is a cutaway side view of the laptop anti-theft device 100 in the laptop restraint position 204. The second retention member engagement surface 222 of the second retention member 220 may have partially engaged the back surface 128 of the monitor portion 122. In some examples, the second retention member engagement surface 222 of the second retention member 220 may remain adjacent to the back surface 128 of the monitor portion 122. The second retention member 220 may be in the laptop restraint position 804 of the second retention member 220. The cam bar latching finger 902 may engage the interference teeth 914 at the void 916 by rotation around the pivot 904. The pivot 904 of the cam bar latching finger 902 may allow movement towards and away from the interference teeth 914 but restrict movement of the cam bar latching finger 902 along the rotation of the cam bar 260. The contact or potential interference between the interference teeth 914 and the latching finger may prevent the second retention member 220 and cam bar 260 from being rotated around the bolt 604. The second retention member 220 may be in the laptop restraint position 804 of the second retention member 220 resulting in the laptop anti-theft device 100 being in the laptop restraint position 204. The first retention member 210 may restrict movement in the first direction 130 when the slot 602 comes into engagement with the bolt 604. The cam bar latching finger 902 interference with the interference teeth 914 may restrict rotation of the cam bar 260 around the bolt 604. The restricted motion of the cam bar 260 may restrict the motion of the second retention member 220. The restricted motion of the second retention member 220 contains the monitor portion 122 of the laptop 120 between the second retention member 220 and the first retention member 210 restricting movement in the second direction 132. The combination of the first retention member 210 in the laptop restraint position 702 of the first retention member 210 and the position of the second retention member 220 in the laptop restraint position 804 of the second retention member 220 may prevent the removal of the laptop 120. The cam bar latching finger 902 may be moved from the laptop restraint position 912 of the cam bar latching finger 902 to the open position 910 of the cam bar latching finger 902 by a rod 1002 connected to the lock 246. The articulation or movement of the lock 246 may move the rod 1002 and resulting cam bar latching finger 902 moving the cam bar latching finger 902 from the open position 910 of the cam bar latching finger 902 to the laptop restraint position 912 of the cam bar latching finger 902 releasing the second retention member 220, allowing the laptop 120 to be removed.

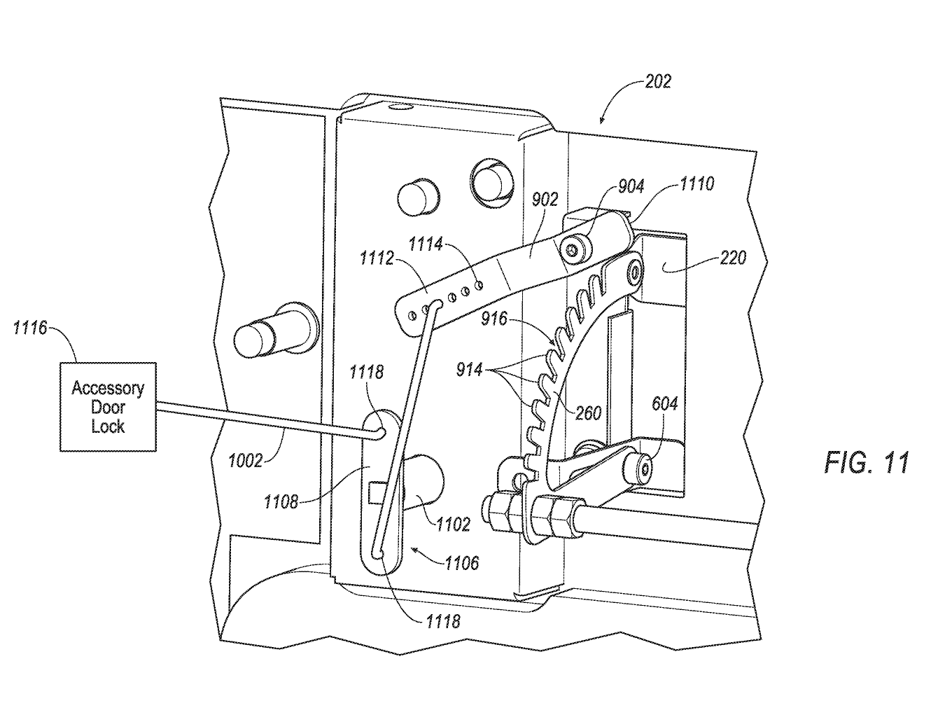

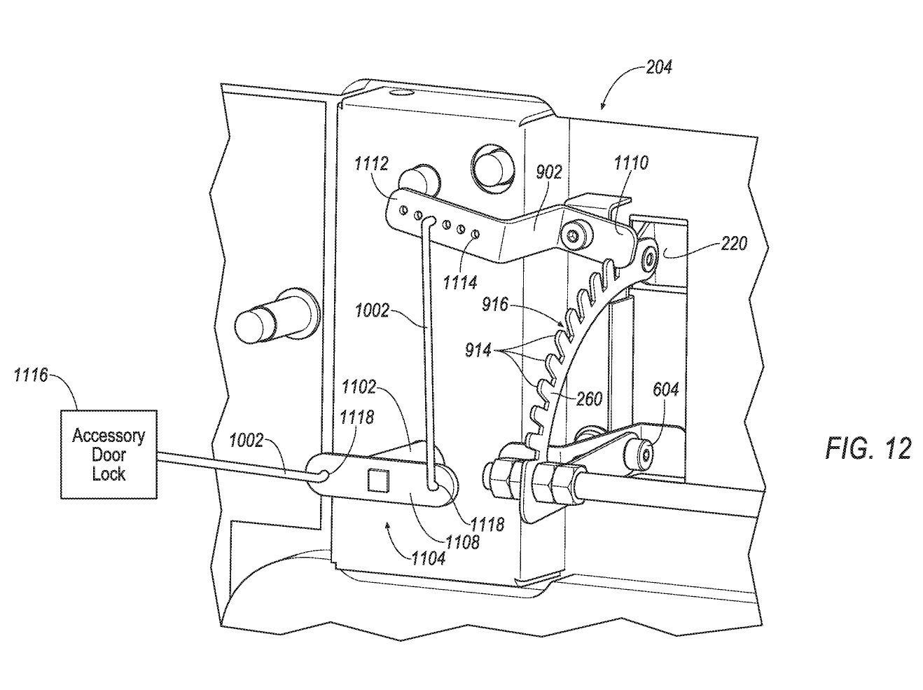

FIG. 11 is an isometric rear view of the laptop anti-theft device 100 in the open position 202. The lock 246 may include a rotatable cylinder 1102 that may be turned when the lock 246 is manipulated or locked/unlocked from a laptop restraint position 1104 (shown in FIG. 12) of the lock 246 to an unlocked position 1106 (shown in FIG. 11) of the lock 246. Attached to the rotatable cylinder 1102 may be a member 1108 including one or more holes 1118. A rod 1002 may connect the member 1008 to the cam bar latching finger 902. The cam bar latching finger 902 may include an engaging end 1110 and a driving end 1112. The engaging end 1110 and the driving end 1112 may be separated by the pivot 904. The engaging end 1110 may engage the interference teeth 914 to restrict movement of the cam bar 260 around the bolt 604 securing the second retention member 220. The driving end 1112 may include one or more holes 1114 configured to engage the rod 1002. The rotation or movement of the lock 246 may cause the rotatable cylinder 1102 and member 1108 to move actuating the rod 1002. The actuation of the rod 1002 may cause the driving end 1112 of the cam bar latching finger 902 to move around the pivot 904 moving the engaging end 1110 of the cam bar latching finger 902, resulting in the engaging end 1110 of the cam bar latching finger 902 moving into the void 916 between the cam bar interference teeth 914. When the cam bar latching finger 902 is within the void 916, the engagement end 1110 of the cam bar latching finger 902 may restrict movement of the cam bar 260 and second retention member 220 locking the laptop 120. The cam bar 260 and second retention member 220 motion may be restricted by the interference between the engagement end 1110 of the cam bar latching finger 902 and the interference teeth 914. The member 1108 of the lock 246 may include additional holes 1118 connected to an additional or common rod 1002. The rod 1002 may be connected to an accessory door lock 1116. The accessory door lock 1116 may restrict the rotation or movement of the accessory door 252 prohibiting access to the accessory pocket 250 when the lock 256 is in the laptop restraint position 1104 (shown in FIG. 12) of the lock 246. When the lock 256 is in the unlocked position 1106, the accessory door lock 1116 may not restrict movement of the accessory door 252 allowing access to the accessory pocket 250.

FIG. 12 is an isometric rear view of the laptop anti-theft device 100 in the laptop restraint position 204. The lock 246 may include the rotatable cylinder 1102 that may be turned when the lock 246 is manipulated from a laptop restraint position 1104 (shown in FIG. 12) of the lock 246 to an unlocked position 1106 (shown in FIG. 11) of the lock 246. Attached to the rotatable cylinder 1102 may be the member 1108 including one or more holes 1118. The rod 1002 may connect the member 1008 to the cam bar latching finger 902. The driving end 1112 of the cam bar latching finger 902 may include one or more holes 1114 configured to engage the rod 1002. The rotation or movement of the lock 246 may cause the rotatable cylinder 1102 and member 1108 to move actuating the rod 1002. The actuation of the rod 1002 may cause the driving end 1112 of the cam bar latching finger 902 to move around the pivot 904 moving the engaging end 1110 of the cam bar latching finger 902, causing the engaging end 1110 of the cam bar latching finger 902 to move into the void 916 between the interference teeth 914. When the cam bar latching finger 902 is within the void 916 or interfering with the cam bar interference teeth 914, the engagement end 1110 of the cam bar latching finger 902 may restrict movement of the cam bar 260 and second retention member 220 locking the laptop 120 (shown in FIG. 12). The member 1108 of the lock 246 may include additional holes 1118 connected to an additional or common rod 1002. The rod 1002 may be connected to an accessory door lock 1116. The accessory door lock 1116 may restrict the rotation of the accessory door 252 prohibiting access to the accessory pocket 250 when the lock 256 is in the laptop restraint position 1104 as shown in FIG. 12.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. An anti-theft device for a laptop having a keyboard portion with a top surface and a monitor portion with a back surface, the device comprising:
a first retention member defining a first retention member top surface opposite a first retention member bottom surface, said first retention member selectively moveable between an open position and a laptop restraint position, wherein the first retention member extends against at least a portion of the top surface of the keyboard portion to limit movement of the laptop when the first retention member is in the laptop restraint position; and
a second retention member, selectively moveable between an open position and a laptop restraint position, wherein the second retention member includes an engagement surface for engaging against at least a portion of the monitor portion to limit movement of the laptop when the second retention member is in the laptop restraint position,
wherein the first retention member and the second retention member limit the movement of the laptop when the first retention member and the second retention member are each in the laptop restraint position, and when the first retention member and the second retention member are in the open position, the first retention member top surface and the second retention member engagement surface are substantially co-planar.

2. The device of claim 1, wherein when the first retention member and the second retention member are in the laptop restraint position, the top surface of the keyboard portion is selectively restrained in a first direction by the first retention member bottom surface, and the back surface of the monitor portion is selectively restrained by the second retention member engagement surface in a second direction, and the first direction and the second direction are substantially perpendicular.

3. The device of claim 2, wherein the first retention member and second retention member are coupled, at least indirectly to a tray, wherein the tray includes a lip extending at least partially along a periphery of the tray.

4. The device of claim 3, wherein the first retention member is linearly slideable, and indirectly coupled to the tray by way of a frame ring.

5. The device of claim 3, wherein the second retention member is indirectly coupled to the tray by way of a pivoting cam bar which is directly coupled to a frame ring.

6. The device of claim 5, further comprising at least one magnet located proximate to at least one of the first retention member or the cam bar.

7. The device of claim 5, wherein the cam bar further comprises at least two interference teeth adapted to engage a cam bar latching finger.

8. The device of claim 7, further comprising a resettable lock configured to move the cam bar from a first cam bar position not engaging the at least two interference teeth and the cam bar latching finger, to a second cam bar position engaging the at least two interference teeth and the cam bar latching finger at least partially prohibiting movement of the cam bar preventing movement of the second retention member from the open position to the laptop restraint position.

9. The device of claim 8, wherein the cam bar further comprises a latching finger pivot and the cam bar pivots around the latching finger pivot to move from the laptop restraint position of the cam bar position to the open position of the cam bar.

10. The device of claim 9, further comprising an accessory door coupled, at least indirectly to the tray by an accessory door pivot, wherein when the cam bar is in the second cam bar position the accessory door has restricted movement around the accessory door pivot.

11. An anti-theft device for a laptop having a keyboard portion with a top surface and a monitor portion with a back surface, the device comprising:
a work platform including a work platform surface, the work platform forming walls that define a work platform opening in the work platform surface,
a first retention member at least indirectly coupled to the work platform and selectively moveable between an open position and a laptop restraint position, wherein the first retention member extends against at least a portion of the top surface of the keyboard portion to limit movement of the laptop when the first retention member is in the laptop restraint position; and
a second retention member, at least indirectly coupled to the work platform, selectively moveable between an open position and a laptop restraint position, said second retention member including an engagement surface for engaging against at least a portion of the monitor portion to limit movement of the laptop when the second retention member is in the laptop restraint position,
wherein when the first and the second retention members are in the laptop restraint position, the laptop is restrained by the work platform surface, the first retention member, and the second retention member.

12. The device of claim 11, wherein the first retention member includes a top surface and when the first retention member and the second retention member are in the open position, the first retention member top surface, the second retention member engagement surface, and the work platform surface are substantially co-planar with one another.

13. The device of claim 12, further comprising a frame ring at least indirectly coupled to a tray at least indirectly coupled to the work platform.

14. The device of claim 13, wherein the first retention member is linearly slideable, and at least indirectly coupled to the tray by way of the frame ring.

15. The device of claim 13, wherein the second retention member is indirectly coupled to the tray by way of a pivoting cam bar which is directly coupled to the frame ring.

16. The device of claim 15, further comprising at least one magnet located proximate to at least one of the first retention member and the cam bar.

17. The device of claim 15, wherein the cam bar further comprises at least two interference teeth adapted to engage a cam bar latching finger.

18. The device of claim 17, further comprising a resettable lock configured to move the cam bar latching finger from an unlocked position not engaging the at least two interference teeth and the cam bar, latching finger to a locked position engaging the at least two interference teeth and the cam bar latching finger at least partially prohibiting movement of the cam bar thereby preventing movement of the second retention member from the laptop restraint position to the open position.

19. The device of claim 18, further comprising an accessory door coupled, at least indirectly to the tray by an accessory door pivot, wherein when the cam bar is in the second cam bar position, the accessory door has restricted movement around the accessory door pivot.

20. An anti-theft device for a laptop having a keyboard portion with a top surface and a monitor portion with a back surface, the device comprising:
a work platform including a work platform surface, the work platform forming walls that define a work platform opening in the work platform surface,
a tray at least indirectly coupled to the work platform;
a frame ring at least indirectly coupled to the tray;
a first retention member that is linearly slideable, at least indirectly coupled to the work platform by way of the tray, defining a first retention member top surface opposite a first retention member bottom surface, selectively moveable between an open position of the first retention member and a laptop restraint position of the first retention member, wherein the first retention member extends against at least a portion of the top surface of the keyboard portion to substantially restrict movement of the laptop when the first retention member is in the laptop restraint position;
a pivoting cam bar including at least two interference teeth adapted to engage a cam bar latching finger coupled at least indirectly to the tray;
a second retention member indirectly coupled to the cam bar and at least indirectly coupled to the work platform, selectively moveable between an open position of the second retention member and a laptop restraint position of the second retention member, wherein a second retention member engagement surface of the second retention member engages against at least a portion of the back surface of the monitor portion to substantially restrict movement of the laptop when the second retention member is in the laptop restraint position; and
a resettable lock configured to move the cam bar latching finger from an unlocked position not engaging the at least two interference teeth and the cam bar, to a locked position engaging the at least two interference teeth and the cam bar latching finger at least partially prohibiting movement of the cam bar preventing movement of the second retention member from the open position to the laptop restraint position,
wherein when the first retention member and the second retention member are in the laptop restraint position, the top surface of the laptop is restrained between the work platform surface and the first retention member bottom surface by the first retention member bottom surface and the back surface of the monitor portion is restrained between the second retention member engagement surface and the first retention member by the second retention member engagement surface and when the first retention member and the second retention member are in the open position, the first retention member top surface, the second retention member engagement surface, and the work platform surface are substantially co-planar.
